(19) United States
(12) Patent Application Publication
(10) Pub. No.: US 2009/0291642 A1
(43) Pub. Date: Nov. 26, 2009

(54) Systems and Methods for SIR Estimation for Power Control

(75) Inventors: Carmela Cozzo, Cary, NC (US); Christer Edholm, Taby (SE); Ning He, Sollentuna (SE)

Correspondence Address: POTOMAC PATENT GROUP PLLC, P. O. BOX 270, FREDERICKSBURG, VA, 22404, US

(73) Assignee: TELEFONAKTIEBOLAGET LM ERICSSON (PUBL), Stockholm (SE)

(21) Appl. No.: 12/126,240

(22) Filed: May 23, 2008

(51) Int. Cl. H04B 17/00

(52) U.S. Cl. 455/67.13

(57) ABSTRACT

Systems and methods according to these exemplary embodiments provide for methods and systems for improving the signal-to-interference-plus-noise ratio (SIR) estimation between a mobile communications device and a base station (BS) for improving power control. A first SIR estimate is generated based on signals received on at least a first channel and a second SIR estimate is generated based on signals received on a second channel. A correction factor for the second SIR estimate is generated based on at least the first SIR estimate, and the second SIR estimate is adjusted with the correction factor. The first SIR estimate can, optionally, be generated using channel coefficients generated from signals received on both the first channel and the second channel.

### TECHNICAL FIELD

The present invention relates generally to communications systems and in particular to methods and systems for estimating the signal-to-interference-plus-noise ratio (SIR) between a mobile communications device and a base station (BS) for improving power control.

### BACKGROUND

In cellular communications systems, service areas are formed by small zones known as cells. Each cell is defined by a particular base station (BS), a NodeB or the like. In wideband spread spectrum cellular communication systems (e.g., Wideband Code Division Multiple Access (WCDMA) systems), since the same frequency band is shared by multiple users, signals of other users become interference signals which may degrade the communication quality of a particular user. When a BS communicates with near and remote mobile stations (MSs) at the same time, it receives the transmitted signal from the near mobile station at a high level, whereas it receives the transmitted signal from the remote mobile station at a much lower level. Thus, communications between the base station and the remote MS present a problem in that the channel quality is sharply degraded by interference from the near MS. This is typically referred to as the near-far problem.

One technique which has been used for solving the near-far problem is controlling transmission power such that the received power at a receiving station, or the signal-to-noise ratio (SNR) or the signal-to-interference-plus-noise ratio (SIR) thereof, is kept fixed regardless of the location of a MS. This provides more consistent channel quality across a given service area. In other words, in WCDMA systems (or CDMA systems) the output power of mobile stations is often controlled, with the goal of transmitting at a power such that the received signal quality at the BS is just sufficient for the desired quality of reception. Such control depends upon the conditions of the signal at issue and upon interference (i.e., interfering signals).

In this regard, a closed loop transmission power control system for WCDMA is known which employs transmission power control bits. In this system, the BS measures the received SIR of the signal received from the MS and determines the transmission power control bits for controlling the transmission power (i.e., uplink power) of the MS on the basis of these measurement results. Then, the BS inserts the transmission power control (PC) bits into its transmitted signal to that MS on the downlink. Receiving the signal from the BS, the MS extracts the transmission power control (PC) bits and determines its transmission power (i.e., uplink power) in accordance with the instructions of the transmission power control (PC) bits. The closed loop thus formed between each MS and the BS enables the BS to control transmission power on the uplink of all the MSs within its service area.

As such, it is important that the power control algorithms used in WCDMA systems be designed to maintain the negotiated quality of the data channels for all active users. Essentially, the basic power control algorithms used in existing systems are designed to implement this capability in each connection, with two nested control loops. The outer (slower) power control loop controls a received signal-to-interference-plus-noise ratio (SIR) or signal-to-noise ratio (SNR) target value for use in the inner (faster) closed power control loop so that the actual Quality of Service (QoS) is close to the negotiated QoS. The inner power control loop estimates the SIR of the uplink channel, compares the estimated SIR to the SIR target value, and based on the results of the comparison, transmits power control commands on the downlink channel which “advise” the transmitter on the uplink channel about whether to increase or decrease its transmission power level. In this example, controlling the power in the uplink direction, the inner power control loop is between the MS and the BS, while the outer power control loop is associated with the radio network controller (RNC).

As improvements to various areas of spread spectrum communications occur it has become possible to increase data rates. For example, in the uplink, higher order modulation (HOM) based on 16 quadrature amplitude modulation (QAM) (or 4×4 pulse amplitude modulation (PAM)) can be introduced to the uplink enhanced data channel (E-DCH) of Universal Mobile Telecommunications Systems (UMTS). The introduction of 16 QAM doubles the data rate with respect to 3GPP Release 6, e.g., enhanced uplink in Release 6, and allows peak data rates up to 11.5 Mbps (with a coding rate equal to 1). The transmission power of the data channel, e.g., enhanced dedicated physical data channel (E-DPDCH), as well as the power of the associated enhanced dedicated control channel (E-DPCCH), depends on the transport format used and it is adapted relative to the dedicated physical control channel (DPCCH) power. The DPCCH power is set by the inner loop power control to reach the SIR target set by the outer loop power control.

Reliable demodulation of high rate signals requires a good phase reference for channel estimation. However, the power settings in Release 6 are not always sufficient to provide the desired level of performance. One method used to improve the phase reference for channel estimation is to boost the power of the enhanced dedicated physical control channel (E-DPCCH) symbols as standardized in 3GPP Release 7. Methods to estimate the channel are described in PCT/SE2007/050989 entitled “Control Channel Symbol Transmission Method and Apparatus”. A system operating in this mode is described as operating in “boosting mode”. In this boosting mode, the power level of the DPCCH tends to be kept at the lowest possible level that still provides good performance for DPCCH detection and for E-DPCCH detection. A lower DPCCH power level also tends to be beneficial from a system capacity perspective.

Regarding SIR estimation, a well known method to compute SIR for DS-CDMA systems employing a Rake receiver structure is to first despread symbols at different path delays, and for each path delay, these despread values are used to obtain a path SIR estimate based on computing a sample mean and a sample variance. The path SIR estimates are then summed to give the overall SIR estimate. For more information regarding SIR for DS-CDMA systems employing a Rake receiver structure, the interested reader is pointed to the paper entitled “Experimental Evaluation of Combined Effect of Coherent Rake Combining and SIR-Based Fast Transmit Power Control for Reverse Link of DS-CDMA Mobile Radio” by K. Higuchi, H. Andoh, M. Sawahashi and F. Adachi, which can be found in IEEE J. Sel. Areas Commun., vol. 18, pp. 15226-1535, August 2000. However, as recognized by applicants, since the SIR is currently estimated in WCDMA systems using the signal power from the averaged DPCCH pilot symbols, a low DPCCH power level can cause a poor SIR estimation, which in turn can negatively impact the operation of the power control loop associated with an MS and a BS. This potentially poor performance of the power control loop can be a limiting factor for achieving high data rates in the uplink direction.

Accordingly the exemplary embodiments described herein provide systems and methods for improving the SIR estimation used by the power control loop.

### SUMMARY

Systems and methods according to the present invention address this need and others by providing systems and methods for improving the SIR estimation used by the uplink power control loop.

According to one exemplary embodiment a method for estimating a signal-to-interference-plus-noise ratio (SIR) for use in power control includes generating a first SIR estimate based on signals received on at least a first channel. A second SIR estimate is generated based on signals received on a second channel. A correction factor is generated for the second SIR estimation based on at least the first SIR estimate and the second SIR estimate is then adjusted using the correction factor.

According to another exemplary embodiment a device includes a communications interface for receiving signals and a processor. The processor uses the received signals to generate a first SIR estimate based on signals received on at least a first channel and to generate a second SIR estimate based on signals received on a second channel. The processor also uses the received signals to generate a correction factor for the second SIR estimate based on at least the first SIR estimate and then uses the correction factor to adjust the second SIR estimate.

### BRIEF DESCRIPTION OF THE DRAWINGS

The accompanying drawings illustrate exemplary embodiments, wherein:

FIG. 1 illustrates a wideband code division multiple access (WCDMA) cellular network according to exemplary embodiments;

FIG. 2 shows power control loops according to exemplary embodiments;

FIG. 3 illustrates using two signal-to-interference-plus-noise ratios (SIRs) for use in power control according to exemplary embodiments;

FIG. 4 shows using two SIRs with scaling factors for use in power control according to exemplary embodiments;

FIG. 5 shows using two SIRs with delay as a factor for use in power control illustrates according to exemplary embodiments;

FIG. 6 illustrates using two channels for estimating the signal-to-interference (SIR) for use in power control according to exemplary embodiments;

FIG. 7 depicts a communications node according to exemplary embodiments; and

FIG. 8 shows a method flow chart for estimating and modifying the SIR for use in power control according to exemplary embodiments.

### DETAILED DESCRIPTION

The following detailed description of the exemplary embodiments of the present invention refers to the accompanying drawings. The same reference numbers in different drawings identify the same or similar elements. Also, the following detailed description does not limit the invention. Instead, the scope of the invention is defined by the appended claims.

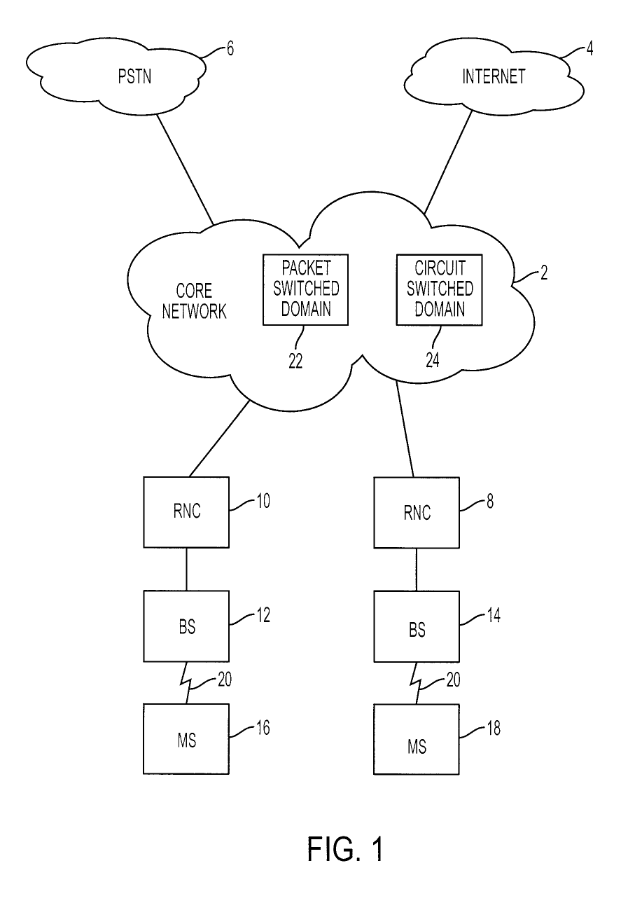

As mentioned above, it is desirable to provide systems and methods for improving the signal-to-interference-plus-noise ratio (SIR) estimation used by the power control loop for devices operating in a Wideband Code Division Multiple Access (WCDMA) environment. However, it will be apparent to one skilled in the art that the present invention may be practiced in other embodiments that depart from these specific details. For example, although the present invention is disclosed in the example context of a mobile radio WCDMA communication system it may also be employed in other types of closed loop power control communications systems such as CDMA, Time Division Multiple Access (TDMA), Long Term Evolution (LTE) and the like. In certain instances, detailed descriptions of well-known methods, interfaces, devices, protocols, and signaling techniques are omitted so as not to obscure the description of the present invention with unnecessary detail. In order to provide context for this discussion, an exemplary WCDMA cellular network will now be described with respect to FIG. 1.

According to exemplary embodiments of the present invention as shown in FIG. 1, a WCDMA cellular network includes a core network 2 which includes a circuit switched domain 24 and a packet switched domain 22. The core network 2 acts as the intermediary between other networks, e.g., the public switched telephone network (PSTN) 6, the Internet (or other Internet Protocol (IP) networks), and radio network controllers (RNCs) 8, 10. These RNCs 8, 10 are further in communication with various base stations 12, 14 or NodeBs, which in turn are in communication with mobile stations (MSs) 16, 18. Radio access over radio interface 20 is based upon WCDMA with individual radio channels allocated using CDMA channelization or spreading codes. Of course, other access methods may be employed, such as TDMA or any other type of CDMA. WCDMA provides wide bandwidth and addresses other high transmission rate demands as well as robust features like diversity handoff to ensure high quality communication service in frequently changing environments. For uplink transmission, each mobile station MS 16, 18 is assigned its own scrambling code in order for a base station 12, 14 to identify transmissions from that particular mobile station 16, 18. For downlink transmission, each mobile station 16, 18 uses its own channelization code to identify transmissions from base stations either on a general broadcast or common channel or on dedicated channels which carry transmissions specifically intended for that MS 16, 18. While not explicitly shown in FIG. 1, more or fewer items can be part of a WCDMA cellular network, e.g., a single RNC 8 will typically be in communication with several base stations and not just the single BS 14 as shown in FIG. 1.

Of particular interest in this specification are the communications between an MS 16 and a BS 12 related to power control, more specifically, for generating and using SIR estimates to improve power control in the uplink (UL) direction. SIR, as described by 3GPP TS 25.215 v8.0 dated March 2008 (as found at www.3gpp.org and incorporated herein by reference), can be defined as shown below in equation (1):

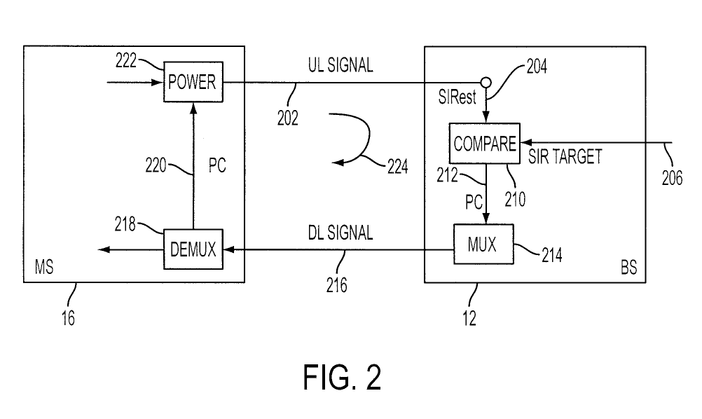

SIR=(RSCP/ISCP)*SF (1)

where RSCP is the received signal code power, ISCP is the interference signal code power and SF is the spreading factor. This SIR calculation is typically performed using the data from a single channel, e.g., the dedicated physical control channel (DPCCH), however other estimates for calculating SIR can be performed according to exemplary embodiments of the present invention using multiple channels as will be described in more detail below. SIR, as this acronym is used in this application, can generally be described as received signal power over the sum of interference plus noise power. Prior to describing exemplary methods for estimating SIR, exemplary power control loops will now be described with respect to FIG. 2.

Using elements of the exemplary architecture shown in FIG. 1, the power control loops of particular interest for exemplary embodiments of the present invention will now be described with respect to FIG. 2. FIG. 2 shows MS 16 in communications with BS 12. Uplink (UL) signal 202 is sent from MS 16 to BS 12. Once UL signal 202 is received by BS 12, a part of the UL signal can be used to estimate SIR 204. The SIR estimate 204 and an SIR target value 206 are received by a comparing (or threshold) function 210, which generates the power control (PC) instructions 212 to be sent back to the MS 16. The SIR target value 206 is received from an RNC (not shown in FIG. 2). PC instructions 212 are then sent to a multiplexing function 214 for inclusion in the downlink (DL) signal 216 which is transmitted back to the MS 16. Once at the MS 16, the DL signal 216 is received at a demultiplexing function 218 with the PC instructions 220 being forwarded to a power amplification function 222 for use on the UL signal 202. Inner power control loop 224 represents the power control loop between the MS 16 and the BS 12. As will be understood by those skilled in the art, both MS 16 and BS 12 can include other functional parts, however, these parts have not been described as they are not directly relevant to the understanding of the power control loops.

As described above, 3GPP TS 25.215 v8 describes SIR estimation using symbols received on the DPCCH. However, according to exemplary embodiments of the present invention, symbols received on other channels, e.g., an enhanced dedicated physical control channel (E-DPCCH), can also be used to perform SIR estimation. For example, when MS 16 is communicating with BS 12, the SIR can be estimated using both DPCCH and E-DPCCH SIR estimations in various ways as will be described in more detail below. Additionally, while the use of both channels for SIR estimation can occur when the MS is operating in boosting mode, i.e., when the MS 16 is boosting the transmit power of the E-DPCCH symbols, the use of both channels for SIR estimation can also occur in a non-boosting mode.

One method for SIR estimation, when the MS 16 is not in a boosting mode, is based upon the SIR being updated every time slot, e.g., every 667 microseconds in the above described exemplary WCDMA system, based on the received DPCCH symbols as shown below in equation (2).

$${SIR}_{est}^{DPCCH} = \frac{{P}^{DPCCH}}{{I}_{ISI}^{DPCCH} + {I}^{E - DPDCH} + {I}^{E - DPCCH} + N} \qquad ( 2 )$$

In equation (2), the denominator includes self interference, the interference generated by the high rate data channel, i.e., the enhanced dedicated physical data channel (E-DPDCH), the interference generated by E-DPCCH and the term N which accounts for interference from other users and thermal noise. The self interference can be considered to be negligible due to the large spreading factor of the DPCCH. Additionally, the interference from the E-DPCCH can also be considered negligible because the E-DPCCH usually operates at a relatively low power as compared to the power used by the E-DPDCH (or multiple E-DPDCHs). Thus, equation (2) can be simplified as shown below in equation (3).

$${SIR}_{est}^{DPCCH} = \frac{{P}^{DPCCH}}{{I}^{E - DPDCH} + N} \qquad ( 3 )$$

Equation (3) shows that the interference generated by the E-DPDCH(s) can severely lower the DPCCH SIR estimate. Exemplary methods for improving the estimate of SIR in, for example, this type of environment are described below in more detail.

According to exemplary embodiments of the present invention the BS 12 can adjust the SIR based on an SIR estimate which is generated using both the received DPCCH symbols (or, more generally, signals) and the received E-DPCCH symbols (or, more generally, signals). Estimating the SIR from both the received DPCCH symbols and the received E-DPCCH symbols can, for example, be performed when the MS 16 is transmitting at a high data rate and is configured to operate in the E-DPCCH boosting mode. However, the estimation of SIR using symbols from multiple channels can also be performed when the MS 16 is not configured in boosting mode, e.g., if the system determines that a better SIR estimation can be obtained by using both control channels, e.g., DPCCH and E-DPCCH, as compared to an SIR estimate which uses the DPCCH only.

As shown above in equation (3), SIRₑₛₜ^{DPCCH} (alternatively written as DPCCH SIR) can be estimated by the BS 12 and, similarly, SIRₑₛₜ^{E-DPCCH} (alternatively written as E-DPCCH SIR) can also be estimated by the BS 12. This latter estimate for SIRₑₛₜ^{E-DPCCH} can, for example, be calculated as shown below in equation (4).

$${SIR}_{est}^{E - DPCCH} \approx \frac{{P}^{E - DPCCH}}{{I}^{E - DPDCH} + N} \qquad ( 4 )$$

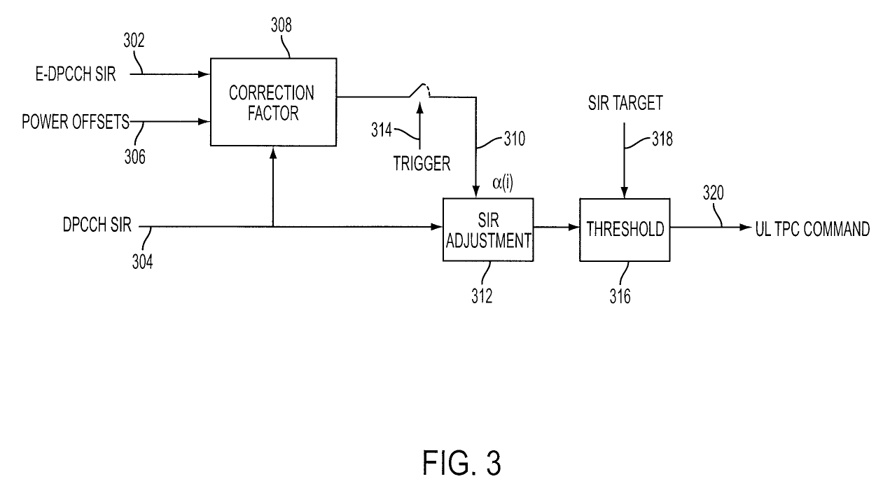

According to exemplary embodiments of the present invention, these two SIR estimates can be used to create a combined SIR estimate for optimizing power control in many settings. An exemplary embodiment using two SIR estimates will now be described with respect to FIG. 3.

Based on the received uplink signal(s) an E-DPCCH SIR 302 is estimated using, for example, equation (4) and a DPCCH SIR 304 is estimated using, for example, equation (3). These two inputs, E-DPCCH SIR 302 and DPCCH SIR 304, are used in conjunction with power offsets 306 by a correction factor function 308 to calculate a correction factor a 310 (or sometimes referred to herein as α[i] to denote a correction factor for a certain time interval, e.g. one time slot), where the correction factor is shown as a function of its inputs in equation (5).

$$α = f ( {SIR}_{est}^{DPCCH} , {SIR}_{est}^{E - DPCCH} , \frac{{β}_{c}^{2}}{{β}_{ec}^{2}} ) \qquad ( 5 )$$

The power offsets for the two channels are set by the system, signaled to the MS 16 and are represented in equation (5) by the β settings. The β settings β_{c} and β_{ec} determine the transmitted power of DPCCH and E-DPCCH. A power control function adjusts the transmitted power of the DPCCH and then the other associated channels are transmitted with an offset relative to the DPCCH's transmitted power. The power offsets 306 are used to scale the SIR estimated from a first channel, e.g., the E-DPCCH, in order for the SIR to reflect the power level of a second channel, e.g. the DPCCH. Also, the function f used to compute a can be any linear or non-linear function. According to exemplary embodiments of the present invention, one method to compute a combined SIR is to average the two SIR estimates. In this case the function f performs an average of the DPCCH SIR and the scaled E-DPCCH SIR, and then divides the resulting value by the estimated DPCCH SIR. Assuming that the quantities are in linear scale, the correction factor a can be written as in equation (6).

$$α = avg ( {SIR}_{est}^{DPCCH} , \frac{{β}_{c}^{2}}{{β}_{ec}^{2}} \cdot {SIR}_{est}^{E - DPCCH} ) - {SIR}_{est}^{DPCCH} \qquad ( 6 )$$

The output, e.g., correction factor α[i] 310, of the correction factor function 308 is then sent to an SIR adjustment function 312 and a combined SIR estimate is computed from the DPCCH SIR and the adjustment factor. Additionally, a trigger or switching function 314 can optionally be provided between the correction factor function 308 and the SIR adjustment function 312. According to an exemplary embodiment, the trigger function 314 is activated based upon the relative powers of the E-DPCCH and the DPCCH. For example, if the power of the E-DPCCH is relatively insignificant as compared to the power of the DPCCH (i.e., the ratio of the two powers is less than a predetermined threshold), then the trigger 314 would not activate and the SIR estimate used to determine the next power control command is based only on the DPCCH estimated SIR 304. This could occur, for example, when the MS 16 is operating in a non-boosting mode and/or a low rate data is being transmitted over the E-DPDCH resulting in low power used by the E-DPCCH. Conversely, if the ratio of the two powers equals or exceeds the optional threshold, then the adjustment to the second SIR estimate can be performed. After the SIR adjustment 312 occurs, the new or combined SIR estimate is forwarded to the threshold function 316 where the combined SIR estimate is compared to a SIR target value 318 which results in an UL transmit power command (TPC) 320 being generated.

Using the exemplary embodiment shown in FIG. 3 and the above described equations, the combined SIR for time slot i can be calculated as shown in equation (7) below.

SIR_{combined}[i]=SIRₑₛₜ^{DPCCH}[i]+α[i] (7)

The combined SIR equation shown as equation (7) assumes no delay between the two SIR estimates. However, depending upon the manner in which the BS 12 selects the symbols from the E-DPCCH for SIR estimation, differing amounts of delay can occur. For example, when decoding the symbols associated with the E-DPCCH the delay can run between 1.6 time slots (e.g., if there is an early E-DCH transport format combination identifier (E-TFCI) detection) up to 3 time slots (e.g., when there is no early E-TFCI detection). This exemplary method for SIR estimation uses the E-DPCCH decoded bits. The decoded bits are then re-encoded and used as “known symbols” to demodulate the E-DPCCH symbols which in turn are used for SIR estimation. The received signal power is computed by averaging the demodulated E-DPCCH symbols and squaring the resulting average value. This method allows for coherently combining the E-DPCCH symbols, calculating the symbol power and symbol variance for use.

As an alternative to the use of decoded bits, detected E-DPCCH symbols can be used as “known symbols” to demodulate the E-DPCCH symbols. The despread E-DPCCH values at each finger are channel compensated and then combined. Detection of the resulting combined values gives the detected E-DPCCH symbols. Similarly to the method described in the previous paragraph that uses the decoded bits, this method allows for coherent combining of the E-DPCCH symbols. This method does not involve the decoder and allows for coherently combining the E-DPCCH symbols of a particular time slot, calculating the symbol power and symbol variance for use. This, in turn, enables exemplary embodiments of the present invention to generate E-DPCCH SIR estimates at the same rate as DPCCH SIR estimates, e.g., every time slot.

As yet another alternative, one can use non-coherent averaging to compute a slot-based SIR. The received signal power is estimated by averaging the squared E-DPCCH despread values of the fingers. This method would give a less accurate estimate. Moreover, a mixture of coherent and non-coherent averaging can be used.

As will be understood by those skilled in the art, other methods of demodulating or decoding the received symbols may be used to generate an estimated SIR for each time slot. For example, the system could initially use demodulated E-DPCCH values for SIR estimation and then switch to using also the decoded information in the process of estimating the SIR when the associated decoded information is ready, e.g., for the first two time slots use only despread values and then use the decoded information for the third slot of a TTI.

Returning to the correction factor α[i] 310, when the delay constraint can be reduced to only a one slot delay, an exemplary method for describing and generating α[i] 310 is shown below in equation (8).

$$α [ i ] = f ( {SIR}_{est}^{DPCCH} [ i ] , {SIR}_{est}^{E - DPCCH} [ i ] , \frac{{β}_{c}^{2}}{{β}_{ec}^{2}} ) \qquad ( 8 )$$

For exemplary cases, when the delay (D) is longer than one time slot, the correction factor α[i] 310 used to generate the combined SIR in slot i can be described and generated as shown below in equations (9) and (10).

$$\begin{matrix}α [ i ] = f ( {SIR}_{est}^{DPCCH} [ i ] , {SIR}_{est}^{E - DPCCH} [ i - D ] , \frac{{β}_{c}^{2}}{{β}_{ec}^{2}} ) & ( 9 ) \\ α [ i ] = f ( {SIR}_{est}^{DPCCH} [ i - D ] , {SIR}_{est}^{E - DPCCH} [ i - D ] , \frac{{β}_{c}^{2}}{{β}_{ec}^{2}} ) & ( 10 )\end{matrix}$$

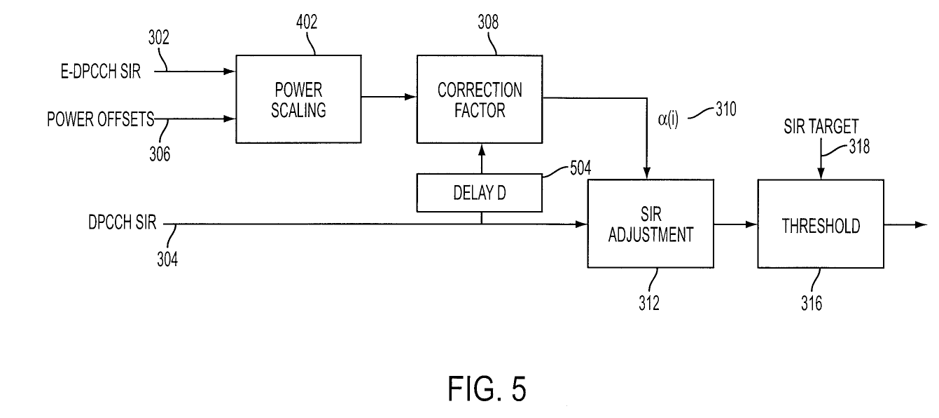

Preferably, the correction factor α[i] 310 is updated as frequently as possible, e.g. every slot, and computed from both the E-DPCCH and DPCCH SIR estimates, estimated in the same time interval in which the correction factor adjusts the DPCCH SIR 304 at the SIR adjustment function 312. However, this will not always be the case, and the SIR estimates used to compute the correction factor can have different delays. In general, even if the delays of the SIR estimates used in the correction factor are the same, the DPCCH SIR estimate adjusted by the correction factor may have a different delay. FIG. 5, illustrates the case when a delay D is present between the DPCCH SIR estimate and the correction factor.

As another example, the system could initially use only the DPCCH SIR estimation, then when the E-DPCCH SIR estimation becomes available (might be delayed if based on the E-DPCCH decoded signal), start using the combined SIR estimation as shown in FIG. 5. The correction factor used to obtain the combined SIR can be updated continuously (every slot) based only on DPCCH SIR estimate when E-DPCCH SIR is not available, or it can be kept fixed until the next time interval when the E-DPCCH SIR estimate becomes available.

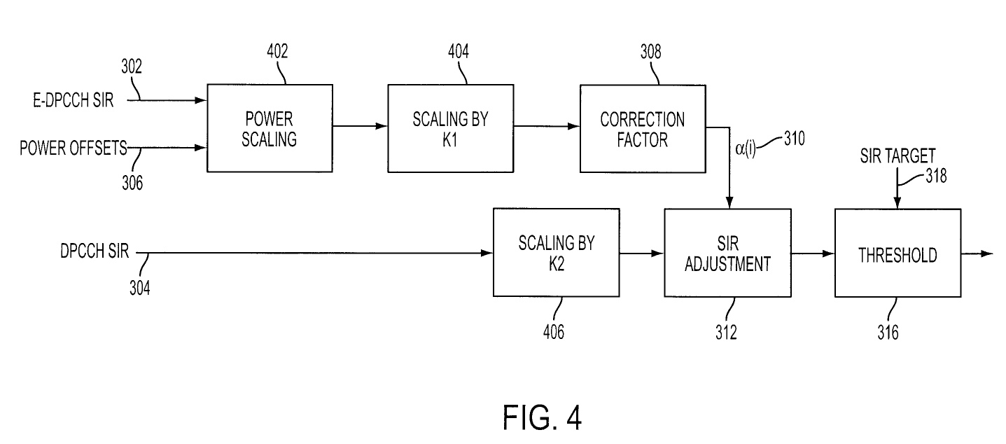

According to yet another exemplary embodiment, scaling factors can be used to modify the SIR estimates prior to their use in SIR adjustment function 312 as shown in FIG. 4. Initially, the SIR estimation is performed as previously described above with respect to FIG. 3. More specifically, the SIR estimate from the E-DPCCH is calculated, scaled by the power scaling function 402 depending upon the power offsets 306. This SIR estimate is then scaled by scaling factor k₁ 404 prior to calculating the correction factor α[i] 310 by the correction factor function 308 and providing input to the SIR adjustment function 312. Similarly, the DPCCH SIR 304 undergoes scaling by scaling factor k₂ 406 prior to being input into the SIR adjustment function 312. Scaling factors k₁ and k₂ can be used to give more weight to the most accurate estimate between the two SIR estimates being used by the SIR adjustment function 312. Scaling factors k₁ and k₂ are numbers between 0 and 1 inclusive, with the sum of k₁ plus k₂ equaling 1. Using this information, the adjusted SIR output from block 312 in linear can be calculated as shown below in equation (11).

$${SIR}_{combined} = {SIR}_{est}^{DPCCH} \cdot {k}_{2} + {SIR}_{est}^{E - DPCCH} \cdot ( \frac{{β}_{c}^{2}}{{β}_{ec}^{2}} ) \cdot {k}_{1} \qquad ( 11 )$$

This then leads to the calculation of the correction factor α[i] 310, when using scaling factors k₁ and k₂, as shown below in equation (12).

$$α = {SIR}_{est}^{E - DPCCH} \cdot ( \frac{{β}_{c}^{2}}{{β}_{ec}^{2}} ) \cdot {k}_{1} \qquad ( 12 )$$

According to another exemplary embodiment, e.g., for use at very high data rates when in boosting mode, the DPCCH power is significantly lower than the E-DPCCH power which can allow the combined SIR in decibels to be computed using only the E-DPCCH SIR estimate scaled by the power offsets, i.e., the case where k₁=1 and k₂=0, which leads the combined SIR to be calculated as shown below in equation (13).

$${SIR}_{combined} = {SIR}_{est}^{E - DPCCH} \cdot ( \frac{{β}_{c}^{2}}{{β}_{ec}^{2}} ) \qquad ( 13 )$$

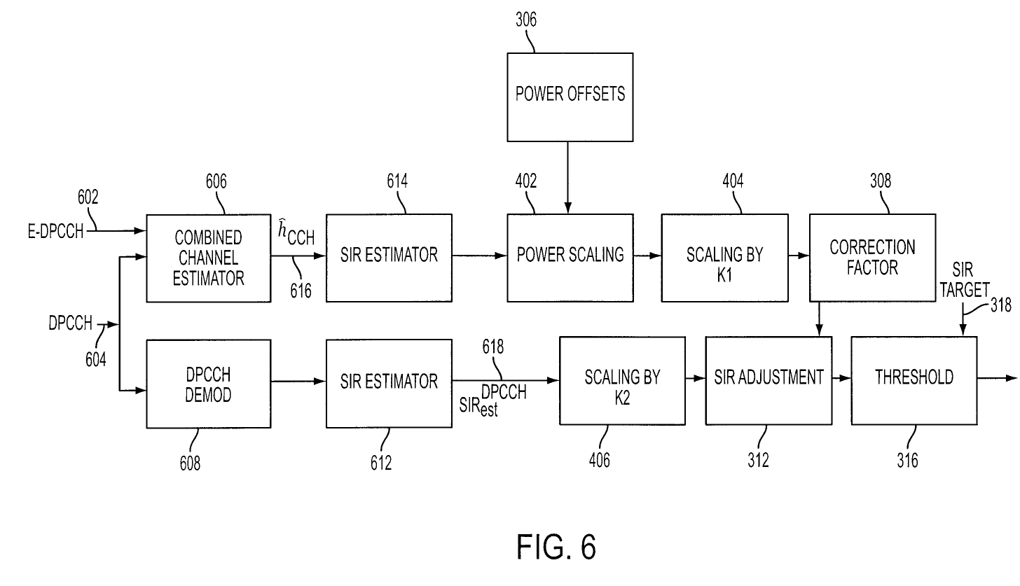

As described above in the various exemplary embodiments of FIGS. 3-5, the first SIR estimate can be based upon the signal from the E-DPCCH and the second SIR estimate can be based upon the signal from the DPCCH. According to another exemplary embodiment, the first SIR estimate can be based upon the signal from both the E-DPCCH 602 and the DPCCH 604 and the second SIR estimate can be based upon the signal from the DPCCH 604 as shown in FIG. 6. Following the path of the first SIR estimate, the E-DPCCH received signals 602 and the DPCCH received signals 604 are used in the combined channel estimator 606 to create a combined channel estimate ĥ_{CCH} 616. This combined channel estimate ĥ_{CCH} 616 is then used by an SIR estimator function 614 to create a first SIR estimate which is then used in conjunction with the power offsets 306 to undergo power scaling 402. Following scaling by k₁ 404, the correction factor function 308 calculates a correction factor α[i] 310 for use by the SIR adjustment function 312.

Following the path of the second SIR estimate in FIG. 6, the DPCCH symbols 604 undergo DPCCH demodulation by a DPCCH demodulation function 608. These demodulated DPCCH symbols are then used by a SIR estimator function 612 to create an estimated DPCCH SIR 618. The DPCCH SIR estimate 618 then undergoes scaling by k₂ 406, the output of which is then used by the SIR adjustment function 312 along with the correction factor α[i] 310 to send an adjusted SIR value to the threshold function 316 for comparison with the SIR target value 318. Also, as described in previous embodiments, the power offsets represent relative power between the two sets of channel symbols, and the scaling factors of k₁ and k₂ are numbers between 0 and 1 with the sum of k₁ plus k₂ being equal to 1. Additionally, while not shown in FIG. 6, this exemplary embodiment can be modified to account for delay as previously described.

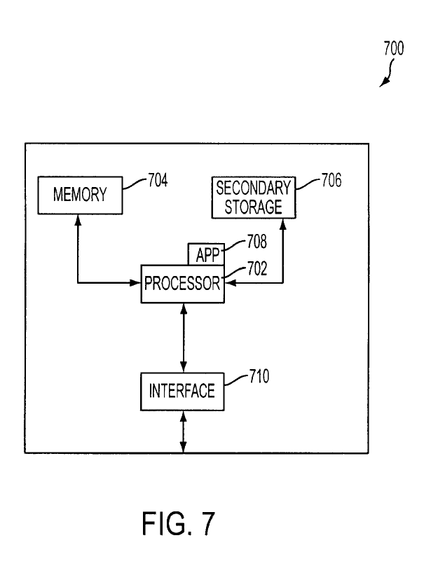

The exemplary embodiments of the present invention described above illustrate methods and systems for using improved SIR estimates to improve the power control loop, e.g., the uplink power control loop, between an MS 16 and a BS 12. An exemplary communications node 700, representing either an MS 16 or a BS 12, will now be described with respect to FIG. 7. Communications node 700 can contain a processor 702 (or multiple processor cores), memory 704, one or more secondary storage devices 706, a software application (or multiple applications) 708 and an interface unit 710 to facilitate communications between communications node 700 and the rest of the network. The interface unit 710 can, for example, include a wireless transceiver having the aforementioned demodulator, decoder, etc. The software application 708 in conjunction with the processor 702 and memory 704 can execute instructions and perform functions used in the SIR estimation and power control loop process such as, for example, correction factor computation, SIR estimation, determining the values of the weighting factors k₁, k₂ and the like, which have been described above.

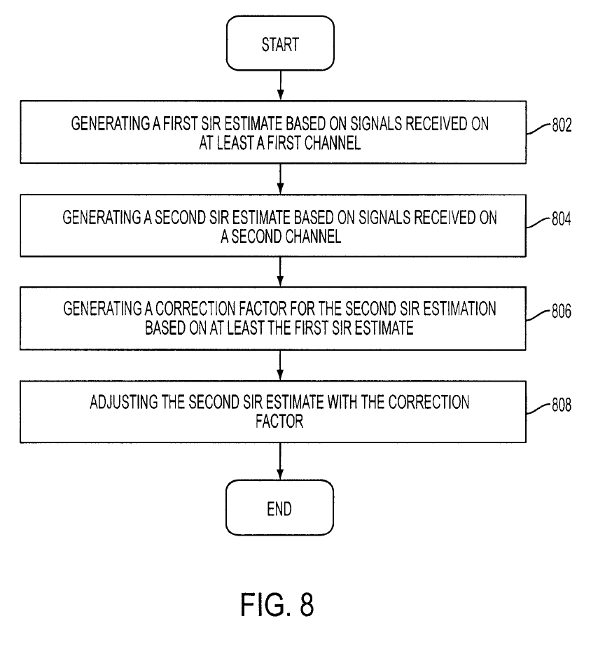

Utilizing the above-described exemplary systems according to exemplary embodiments of the present invention, a method for estimating and modifying the signal-to-interference ratio (SIR) is shown in the flowchart of FIG. 8. Initially a method for estimating a signal-to-interference ratio (SIR) for use in power control includes: generating a first SIR estimate based on signals received on at least a first channel (e.g., an uplink E-DPCCH) in step 802; generating a second SIR estimate based on signals received on a second channel (e.g., an uplink DPCCH) in step 804; generating a correction factor for the second SIR estimation based on at least the first SIR estimate in step 806; and adjusting the second SIR estimate with the correction factor in step 808.

The above-described exemplary embodiments of the present invention are intended to be illustrative in all respects, rather than restrictive, of the present invention. For example, the functions of power scaling, scaling by k₁ and k₂ as well as the correction factor computation can reside within the same piece of hardware, different pieces of hardware, be performed by software or any combination thereof as desired. Additionally, while the E-DPCCH is shown as an exemplary channel to use in addition to the DPCCH for SIR estimation, other channels could also be used instead of the E-DPCCH depending upon the other channel's relative power as compared to the DPCCH. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A method for estimating a signal-to-interference-plus-noise ratio (SIR) for use in power control comprising:
generating a first SIR estimate based on signals received on at least a first channel;
generating a second SIR estimate based on signals received on a second channel;
generating a correction factor for said second SIR estimate based on at least said first SIR estimate; and
adjusting said second SIR estimate with said correction factor.

2. The method of claim 1, further comprising:
comparing said adjusted second SIR estimate with a SIR target value; and
adjusting an uplink transmit power control command based on said comparison.

3. The method of claim 1, further comprising:
scaling said first SIR estimate with a first scaling factor; and
scaling said second SIR estimate with a second scaling factor.

4. The method of claim 3, wherein said first and second scaling factors are each a number between 0 and 1 inclusive, further wherein a sum of said first and second scaling factors equals

5. The method of claim 1, wherein said correction factor is calculated using at least said first SIR estimate and a ratio associated with transmit powers of said first channel and said second channel.

6. The method of claim 1, wherein said correction factor is calculated using said first SIR estimate and said second SIR estimate, and a ratio associated with transmit powers of said first channel and said second channel.

7. The method of claim 1, wherein said signals received on at least a first channel includes signals received on both said first channel and said second channel.

8. The method of claim 1, wherein said first SIR estimate and said second SIR estimate are determined at the same rate and wherein said first SIR estimate is generated using detected symbols.

9. The method of claim 1, wherein said first SIR estimate and said second SIR estimate are determined at different rates and wherein said first SIR estimate is generated based upon decoded symbols or bits.

10. The method of claim 1, wherein said second channel is a dedicated physical control channel and said first channel is an enhanced dedicated physical control channel.

11. The method of claim 1, wherein said step of generating a first SIR estimate based on signals received on at least a first channel further comprises:
using channel estimates from both said first channel and said second channel to generate said first SIR estimate.

12. The method of claim 1, wherein said step of adjusting further comprises:
adjusting said second SIR estimate with said correction factor only when a transmit power of said first channel relative to a transmit power of said second channel is equal to or greater than a predetermined threshold.

13. A device comprising:
a communications interface for receiving signals; and
a processor which uses said received signals to:
generate a first SIR estimate based on signals received on at least a first channel;
generate a second SIR estimate based on signals received on a second channel;
generate a correction factor for said second SIR estimation based on at least said first SIR estimate; and
adjust said second SIR estimate with said correction factor.

14. The device of claim 13, wherein said device is a one of a base station and a NodeB.

15. The device of claim 13, wherein said processor further compares said adjusted second SIR estimate with a SIR target value; and adjusts an uplink transmit power control command based on said comparison.

16. The device of claim 13, wherein said processor further scales said first SIR estimate with a first scaling factor; and scales said second SIR estimate with a second scaling factor.

17. The device of claim 16, wherein said first and second scaling factors are each a number between 0 and 1 inclusive, further wherein a sum of said first and second scaling factors equals 1.

18. The device of claim 13, wherein said correction factor is calculated using at least said first SIR estimate and a ratio associated with transmit powers of said first channel and said second channel.

19. The device of claim 13, wherein said correction factor is calculated using said first SIR estimate and said second SIR estimate, and a ratio associated with transmit powers of said first channel and said second channel.

20. The device of claim 13, wherein said signals received on at least a first channel includes signals received on both said first channel and said second channel.

21. The device of claim 13, wherein said first SIR estimate and said second SIR estimate are determined by said processor at the same rate and wherein said first SIR estimate is generated using detected symbols.

22. The device of claim 13, wherein said first SIR estimate and said second SIR estimate are determined by said processor at different rates and wherein said first SIR estimate is generated based upon decoded symbols or bits.

23. The device of claim 13, wherein said processor uses channel estimates from both said first channel and said second channel to generate said first SIR estimate.

24. The device of claim 13, wherein said processor adjusts said second SIR estimate with said correction factor only when a transmit power of said first channel relative to a transmit power of said second channel is equal to or greater than a predetermined threshold.

25. The device of claim 13, wherein said second channel is a dedicated physical control channel and said first channel is an enhanced dedicated physical control channel.
